(19) United States
(12) Patent Application Publication
(10) Pub. No.: US 2014/0248486 A1
(43) Pub. Date: Sep. 4, 2014

(54) NONFLAMMABLE THERMAL INSULATING SHEET, APPARATUS FOR MANUFACTURING SAME, AND METHOD FOR MANUFACTURING SAME

(71) Applicant: Yong-Soon Sin, Seongnam (KR)

(72) Inventor: Yong-Soon Sin, Seongnam (KR)

(21) Appl. No.: 14/279,932

(22) Filed: May 16, 2014

Related U.S. Application Data
(63) Continuation of application No. PCT/KR2012/009212, filed on Nov. 5, 2012.

(30) Foreign Application Priority Data
Nov. 17, 2011 (KR) 10-2011-0120457

(51) Int. Cl. E04B 1/78; E04B 1/76; B32B 37/02; E04C 2/296

(52) U.S. Cl. CPC E04B 1/78; E04C 2/296; E04B 1/7658; B32B 37/02; E04B 2001/7691
USPC 428/221; 156/563

(57) ABSTRACT

A nonflammable insulating sheet and an apparatus and method for manufacturing the same are disclosed. The disclosed nonflammable insulating sheet includes: a glass fiber fabric having a nonflammable coating layer formed on one side or both sides; an aluminum film arranged on one side of the glass fiber fabric; and another glass fiber fabric arranged on the side of the aluminum film opposite from the glass fiber fabric and having a nonflammable coating layer formed on one side or both sides, where the nonflammable insulating sheet is formed by forming a fire-retardant adhesive layer on both sides of the aluminum film and pressing with the aluminum film arranged between the glass fiber fabrics.

### CROSS-REFERENCE TO RELATED APPLICATIONS

The present application is a continuation of PCT International Application No. PCT/KR2012/009212 filed on Nov. 5, 2012, which claims priority to Korean Application No. 10-2011-0120457 filed on Nov. 17, 2011. The disclosures of the above patent applications are incorporated herein by reference in their entirety.

### BACKGROUND

1. Technical Field

The present invention relates to a nonflammable insulating sheet and an apparatus and a method for manufacturing the same, more particularly to a nonflammable insulating sheet and an apparatus and method for manufacturing the nonflammable insulating sheet in which an aluminum film is attached with a flame-retardant adhesive between stacked layers of glass fiber fabric that are evenly permeated with a nonflammable coating layer on both sides, so as to maintain stiffness for easy cutting, provide thermal insulation and fire-retardant properties to not only prevent fires but also provide a significant delaying effect in the event of a fire occurring due to other causes by suppressing the spreading of flames to the reverse side of the product, release very little toxic gases to allow sufficient time for persons to evacuate and thus reduce casualties, and provide the effects of light isolation, heat preservation, and cool preservation simultaneously.

2. Description of the Related Art

Generally, in various fire accidents, damage may be exacerbated by fabrics that are highly flammable, and in recent times, nonflammable fabrics or fire-retardant fabrics have been proposed that include nonflammable or fire-retardant materials that do not burn easily.

A nonflammable fabric or a fire-retardant fabric may involve coating a nonflammable resin over a fabric of special fibers or regular fibers, to make the fabric resistant to flames. Typically, glass fiber fabrics, non-woven fabrics, and other fabrics that require fire-retardant properties may be selected as the base fabric.

While various methods have been proposed for manufacturing such a nonflammable or fire-retardant fabric, generally the fiber thread may be manufactured using a synthetic resin such as polyester, acrylic, polypropylene, etc., or glass fiber and the like.

Then, a weaving process may be performed, with the manufactured fiber threads woven as lateral and longitudinal threads by a separate weaver, to preliminarily complete a fiber fabric.

The fiber fabric that is thus preliminarily completed by a weaving process may be subjected to a post-treatment method for bonding the lateral and longitudinal threads together to prevent unraveling of the threads and render a suitable degree of stiffness to the fabric. The post-treatment method may comprise a coating process of applying a coating fluid having a nonflammable property and a drying process of drying the applied coating fluid. In this way, the final product may be completed.

Typically, a nonflammable fabric refers to a fabric that is almost invulnerable to burning, while a fire-retardant fabric refers to a fabric that is difficult to burn but is vulnerable to burning with the passage of time. Thus, a nonflammable fabric is more resistant to flames than a fire-retardant fabric, and in order to enhance the nonflammable property, it may be preferable to use a glass fiber fabric.

An invention relating to a nonflammable glass fiber fabric has been proposed in Korean Patent Publication No. 10-2009-0095822.

### SUMMARY

A conventional nonflammable fabric may attempt to provide a nonflammable property by stacking nonflammable coating layers onto a glass fiber fabric, but in actuality, the result merely provides a fire-retardant property and not a nonflammable property, failing to provide sufficient nonflammability in the event of a fire.

Also, while it may be preferable to weave a fabric with thick glass fiber threads in order to provide a greater nonflammable property, the weaving becomes more complicated and difficult the greater the thickness of the glass fiber. The loose quality of the threads may require winding in small amounts, so that there may be numerous connecting portions, which results in much loss of materials, and the connecting portions may break during drying, due to the high temperatures, making it difficult to weave a fabric with thick glass fiber threads.

Also, in a conventional fire-retardant fabric, the fire-retardant coating fluid may not permeate evenly into the fiber fabric, so that the nonflammable property may be significantly degraded in the event of a fire, and the components of the coating fluid may not be soft, so that the manufactured fabric may not be smooth to the touch.

Thus, there is a need to improve the problems above.

To meet this need, an objective of the present invention is to provide a nonflammable insulating sheet and an apparatus and a method for manufacturing the same, where the nonflammable insulating sheet includes an aluminum film between glass fiber fabrics which have nonflammable coating layers permeated evenly on both sides for providing a thermally insulating property and a fire-retardant property, to not only prevent fires but also provide a significant delaying effect in the event of a fire occurring due to other causes by suppressing the spreading of flames to the reverse side of the product, release very little toxic gases to allow sufficient time for persons to evacuate and thus reduce casualties, and provide the effects of light isolation, heat preservation, and cool preservation simultaneously.

Another objective of the present invention is to provide a nonflammable insulating sheet and an apparatus and a method for manufacturing the same, where the nonflammable insulating sheet includes a fire-retardant adhesive layer between the multiple fire-retardant treated glass fiber fabrics and the aluminum film for maintaining stiffness in the glass fiber fabric to allow fastening onto a wall by staples, nails, pieces, etc., when applied for thermal insulation in a building, allow attaching by wallpaper glue or adhesive, and allow easy cutting by cutters, scissors, etc.

Another objective of the present invention is to provide a nonflammable insulating sheet and an apparatus and a method for manufacturing the same, where the nonflammable coating layer permeates evenly through the fibers of the glass fiber fabric, so that when the nonflammable insulating sheet is cut, the amount of glass fiber fabric exposed at the cut surface may be minimized for superior nonflammability, and where melamine or water-based acryl, which have soft components, is included in the nonflammable coating layer so that the glass fiber fabric has a soft and smooth property.

To achieve the objectives above, an embodiment of the present provides a nonflammable insulating sheet that includes: a glass fiber fabric having a nonflammable coating layer formed on one side or both sides; an aluminum film arranged on one side of the glass fiber fabric; and another glass fiber fabric arranged on the side of the aluminum film opposite from the glass fiber fabric and having a nonflammable coating layer formed on one side or both sides, where the nonflammable insulating sheet is formed by forming a fire-retardant adhesive layer on both sides of the aluminum film and pressing with the aluminum film arranged between the glass fiber fabrics.

The aluminum film may be an aluminum foil processed by rolling an aluminum material or an aluminum alloy to a predetermined thickness.

The nonflammable coating layer may include water and melamine cyanurate, water-based polyurethane, and a surface treatment agent.

The nonflammable coating layer may further include one or more of melamine and water-based acrylic, to provide a smooth surface.

The nonflammable coating layer may further include at least one or more of phosphorus pentoxide (P2O5), nitrogen, and urea, to increase nonflammability.

The nonflammable coating layer may be coated by a repeated up-and-down transporting by a multiple number of rollers that are installed immersed in a container holding a nonflammable coating fluid, and printing may be applied on an externally exposed surface of the glass fiber fabric and the another glass fiber fabric.

To achieve the objectives above, an embodiment of the present provides an apparatus for manufacturing a nonflammable insulating sheet that includes: a first coating unit configured to supply an aluminum film and coat with a fire-retardant adhesive layer; a first attachment unit configured to transport the aluminum film coated with the adhesive, supply a glass fiber fabric having a nonflammable coating layer formed thereon, and attach the glass fiber fabric with the aluminum film; a second coating unit configured to transport the glass fiber fabric and the aluminum film in a combined state and coat a fire-retardant adhesive layer onto the other side of the aluminum film; a second attachment unit configured to supply another glass fiber fabric having a nonflammable coating layer formed thereon to the aluminum film and attach with the fire-retardant adhesive layer coated on the other side of the aluminum film to thereby manufacture a nonflammable insulating sheet; and a supplementary attachment unit configured to press both sides of the nonflammable insulating sheet dispensed from the second attachment unit with a plurality of rollers.

The first coating unit may include: a first coating roller configured to transport the aluminum film supplied from a supply roller and apply an adhesive held in a container to thereby form a fire-retardant adhesive layer on one side; and a first pressing roller contacting the first coating roller to aid the transporting of the aluminum film.

The first attachment unit may include: a first attaching roller contacting a back side of the aluminum film coated with the fire-retardant adhesive layer to transport the aluminum film; and a second attaching roller contacting one side of the glass fiber fabric to aid the attachment of the glass fiber fabric and the aluminum film.

The second coating unit may include: a second coating roller configured to transport the combined glass fiber fabric and aluminum film and apply an adhesive held in a container to thereby form a fire-retardant adhesive layer on the other side of the aluminum film; and a second pressing roller contacting the second coating roller to aid the transporting of the combined glass fiber fabric and aluminum film.

The second attachment unit may include: a third attaching roller transporting the glass fiber fabric and the aluminum film coated with the fire-retardant adhesive layer; and a fourth attaching roller contacting one side of the other glass fiber fabric to aid the attachment of the other glass fiber fabric and the aluminum film.

The apparatus may further include a supplementary attachment unit configured to aid attachment by pressing both sides of the nonflammable insulation sheet with multiple rollers as the nonflammable insulation sheet is dispensed from the second attachment unit.

To achieve the objectives above, an embodiment of the present provides a method for manufacturing a nonflammable insulating sheet that includes: a first coating operation of coating a fire-retardant adhesive layer onto one side of an aluminum film; a first combining operation of pressing together the aluminum film and a glass fiber fabric having a nonflammable coating layer formed on one side or both sides to thereby combine the aluminum film with the glass fiber fabric; a second coating operation of coating a fire-retardant adhesive layer onto the other side of the aluminum film; and a second combining operation of pressing together the aluminum film having the fire-retardant adhesive layer coated on the other side thereof and another glass fiber fabric having a nonflammable coating layer formed on one side or both sides to thereby manufacture the nonflammable insulating sheet.

After the second combining operation, the method may further include a supplementary pressing operation of further pressing the nonflammable insulating sheet by using a pair of rollers of a supplementary attachment unit; and a winding operation of winding the nonflammable insulating sheet onto a winding roller.

The nonflammable coating layer may include one or more of melamine and water-based acrylic, and may be formed by mixing melamine cyanurate, water-based polyurethane, a surface treatment agent, and water; the nonflammable coating layer may further include at least one or more of phosphorus pentoxide (P2O5), nitrogen, and urea to increase nonflammability; and the aluminum film may be an aluminum foil processed by rolling an aluminum material or an aluminum alloy to a predetermined thickness.

With the nonflammable insulating sheet and the apparatus and method for manufacturing the nonflammable insulating sheet according to an aspect of the present invention as described above, the nonflammable insulating sheet can include an aluminum film between glass fiber fabrics which have nonflammable coating layers permeated evenly on both sides for providing a thermally insulating property and a fire-retardant property, to not only prevent fires but also provide a significant delaying effect in the event of a fire occurring due to other causes by suppressing the spreading of flames to the reverse side of the product, release very little toxic gases to allow sufficient time for persons to evacuate and thus reduce casualties, and provide the effects of light isolation, heat preservation, and cool preservation simultaneously.

Also, according to an aspect of the present invention, the nonflammable insulating sheet can include a fire-retardant adhesive layer between the multiple fire-retardant treated glass fiber fabrics and the aluminum film for maintaining stiffness in the glass fiber fabric to allow fastening onto a wall by staples, nails, pieces, etc., when applied for thermal insulation in a building, allow attaching by wallpaper glue or adhesive, and allow easy cutting by cutters, scissors, etc.

Also, according to an aspect of the present invention, the nonflammable coating layer can permeate evenly through the fibers of the glass fiber fabric, so that when the nonflammable insulating sheet is cut, the amount of glass fiber fabric exposed at the cut surface may be minimized for superior nonflammability. Also, melamine or water-based acryl, which have soft components, can be included in the nonflammable coating layer so that the glass fiber fabric can be made to have a soft and smooth property.

Also, according to an aspect of the present invention, a fire-retardant adhesive layer can be formed between a glass fiber fabric treated with fire-retardant and an aluminum film, to almost eliminate dust, powders, etc., which may otherwise occur in minute forms during cutting.

Also, according to an aspect of the present invention, several layers of the glass fiber fabric can be attached on either side of the aluminum foil, and the product can be applied as sheets for floors, ceilings, curtains, and blinds, allowing for various usages.

### BRIEF DESCRIPTION OF THE DRAWINGS

FIG. 1 is an exploded perspective view of a nonflammable insulating sheet according to an embodiment of the present invention.

FIG. 2 is a cross-sectional view illustrating the attachment state of a nonflammable insulating sheet according to an embodiment of the present invention.

FIG. 3 is a diagram illustrating the composition of an apparatus for manufacturing a nonflammable insulating sheet according to an embodiment of the present invention.

FIG. 4 is a flow diagram of a method for manufacturing a nonflammable insulating sheet according to an embodiment of the present invention.

### DETAILED DESCRIPTION

A nonflammable insulating sheet and an apparatus and a method for manufacturing the nonflammable insulating sheet according to an embodiment of the present invention will be described below in more detail with reference to the accompanying drawings.

The thickness of a line, the size of an element, or the like, as illustrated in the drawings may be shown in an exaggerated form for greater clarity and convenience of the explanation. Also, the terms used herein were defined in consideration of the functions in the context of the present invention and can vary according to the intent of the user or operator or according to local customs. Therefore, the definitions of such terms are to be interpreted based on the overall descriptions in the present specification.

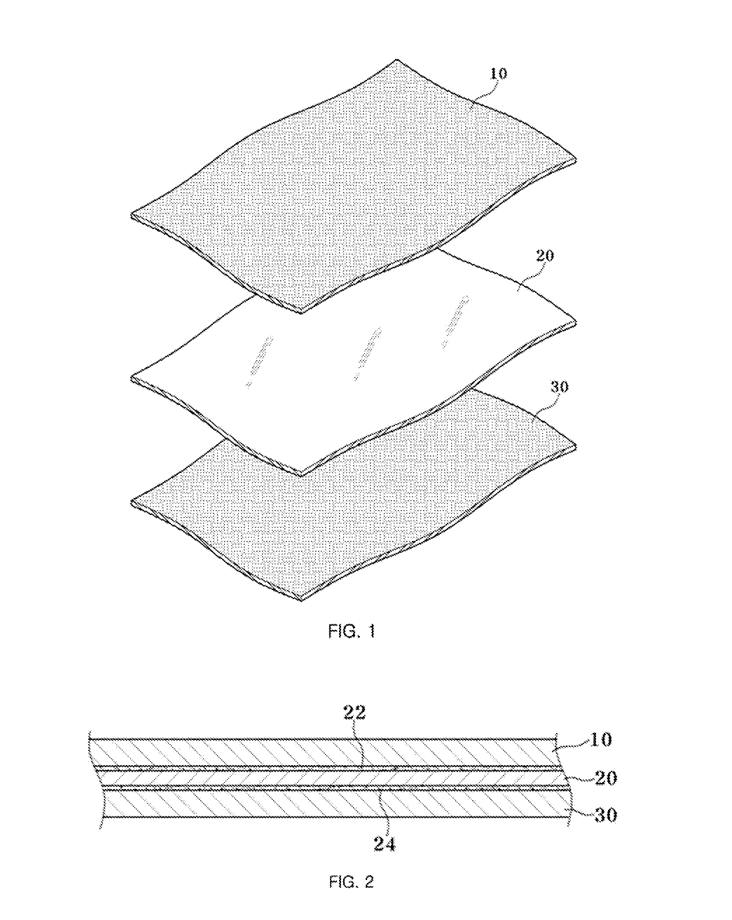

FIG. 1 is an exploded perspective view of a nonflammable insulating sheet according to an embodiment of the present invention, and FIG. 2 is a cross-sectional view illustrating the attachment state of a nonflammable insulating sheet according to an embodiment of the present invention.

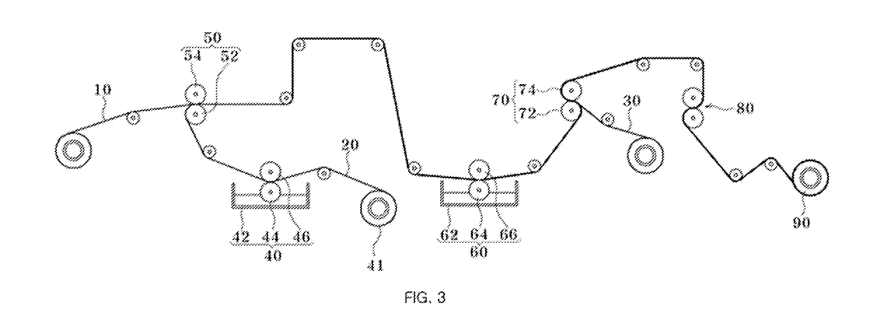

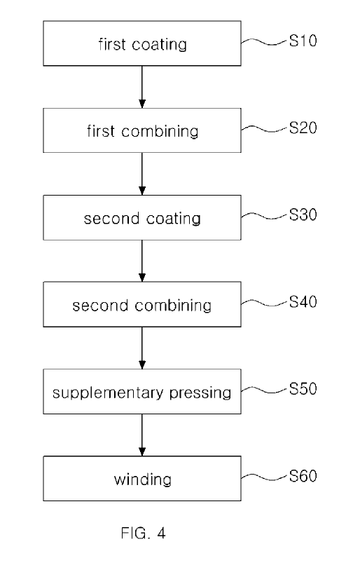

FIG. 3 is a diagram illustrating the composition of an apparatus for manufacturing a nonflammable insulating sheet according to an embodiment of the present invention.

FIG. 4 is a flow diagram of a method for manufacturing a nonflammable insulating sheet according to an embodiment of the present invention.

Referring to FIG. 1 through FIG. 3, a nonflammable insulating sheet according to an embodiment of the present invention may include a glass fiber fabric 10 that has a nonflammable coating layer formed on one side or both sides, an aluminum film 20 arranged on one side of the glass fiber fabric 10, another glass fiber fabric 30 that is arranged on the side of the aluminum film 20 opposite the glass fiber fabric 10 and that has a nonflammable coating layer formed on one side or both sides. The nonflammable insulating sheet may be formed by pressing, after forming fire-retardant adhesive layers 22, 24 on both sides of the aluminum film 20 and arranging the aluminum film 20 between the glass fiber fabrics 10, 30.

The aluminum film 20 may be an aluminum foil that is processed by rolling an aluminum material or an aluminum alloy to a predetermined thickness.

It may be advantageous to roll the aluminum film 20 to a small thickness of about 4.3˜250 μm.

The fire-retardant adhesive layer 22 may have a nonflammable or a fire-retardant property, to maintain adhesion between the glass fiber fabrics 10, 30 and the aluminum film 20 as well as prevent burning in the event of a fire.

The fire-retardant adhesive layers 22, 24 can be obtained by adding a nonflammable or a fire-retardant component to a conventional adhesive component.

The fire-retardant adhesive layer 22 may be applied using a first coating roller 44, which may rotate and apply an adhesive held in a container 42 onto one side of the aluminum film 20 supplied from a supply roller 41, and the aluminum film 20 may be transported by using a first pressing roller 46 that contacts the first coating roller 44.

Also, the aluminum film 20 coated with a fire-retardant adhesive layer 22 and the glass fiber fabric 10 may be attached together by using a first attaching roller 52 and a second attaching roller 54.

An adhesive held in a container 62 may be applied to the other side of the combined glass fiber fabric 10 and aluminum film 20 by using a second coating roller 64, which may rotate and coat the adhesive to form a fire-retardant adhesive layer 24 on the other surface of the aluminum film 20.

The combined glass fiber fabric 10 and aluminum film 20 may be transported by using a second pressing roller 66 that contacts the second coating roller 64, and another glass fiber fabric 30 may be supplied and attached as they pass through a third attaching roller 72 and a fourth attaching roller 74, whereby the nonflammable insulating sheet may be manufactured.

In a different example from the one described above, a nonflammable insulating sheet according to an embodiment of the invention an aluminum film 20 coated on both sides with fire-retardant adhesive layers 22, 24 may be supplied between fire-retardant treated glass fiber fabrics 10, 30 that are supplied separately, and pressing may be performed simultaneously with a pair of attachment rollers to manufacture the nonflammable insulating sheet composed of a glass fiber fabric 10, an aluminum film 20, and a glass fiber fabric 30. In this case, the composition of the equipment may be simpler compared to that of the example described above.

A nonflammable coating layer may include water and melamine cyanurate, water-based polyurethane, and a surface treatment agent.

The surface treatment agent may preferably be polyvinyl alcohol (PVA), but other surface treatment agents can be applied as necessary.

A nonflammable coating layer can further include one or more of melamine and water-based acrylic, in order to provide a smooth surface.

A nonflammable coating layer can further include at least one or more of phosphorus pentoxide (P2O5), nitrogen, and urea, for increased nonflammability.

A nonflammable coating layer may be coated by way of a repeated up-and-down transporting of the glass fiber fabrics 10, 30 on a multiple number of rollers that are installed immersed in a container holding a nonflammable coating fluid, such that the nonflammable coating fluid is permeated evenly through the fibers of the fabrics.

Here, the glass fiber fabrics 10, 30 having nonflammable coating fluid dispensed from the container may be moved between a pair of rollers, which may compress and squeeze the glass fiber fabrics so that the nonflammable coating layer may permeate more deeply.

The glass fiber fabrics 10, 30 into which the nonflammable coating fluid is evenly permeated may be dried, and when the glass fiber fabrics 10, 30 treated thus for a fire-retardant property is cut, the amount of fibers of the glass fiber fabric exposed at the cut surface may be minimized, thereby reducing the occurrence of dust and roughness and increasing product quality.

Printing can be performed on surfaces of the glass fiber fabric 10 and the other glass fiber fabric 30 that are exposed to the exterior. The printing can include single-color printing, double-color printing, or triple-color printing as necessary, and the printing work may preferably be performed in a print-drying container.

A nonflammable insulating sheet according to an embodiment of the invention may advantageously be manufactured by an apparatus and a method for manufacturing the nonflammable insulating sheet described below, but can also be manufactured using different processes and manufacturing methods as necessary.

A nonflammable insulating sheet according to an embodiment of the invention can include an aluminum film 20 between glass fiber fabrics 10, 30 treated with fire-retardant for providing a thermally insulating property and a fire-retardant property, to not only prevent fires but also provide a significant delaying effect in the event of a fire occurring due to other causes by suppressing the spreading of flames to the reverse side of the product, release very little toxic gases to allow sufficient time for persons to evacuate and thus reduce casualties, and provide the effects of light isolation, heat preservation, and cool preservation simultaneously.

Referring to FIG. 3, an apparatus for manufacturing a nonflammable insulating sheet according to an embodiment of the invention may include a first coating unit 40 configured to supply an aluminum film 20 and coat it with a fire-retardant adhesive layer 22; a first attachment unit 50 configured to transport the aluminum film coated with the fire-retardant adhesive layer 22, supply a glass fiber fabric 10 having a nonflammable coating layer formed thereon, and attach the glass fiber fabric 10 with the aluminum film 20; a second coating unit 60 configured to transport the glass fiber fabric 10 and the aluminum film 20 in a combined state and coat a fire-retardant adhesive layer 24 onto the other side of the aluminum film 20; and a second attachment unit 70 configured to supply another glass fiber fabric 30 having a nonflammable coating layer formed thereon to the aluminum film 20 and attach with the fire-retardant adhesive layer 24 coated on the other side of the aluminum film 20 to thereby manufacture a nonflammable insulating sheet.

The first coating unit 40 may include a first coating roller 44, which may transport the aluminum film 20 supplied from a supply roller 41 and form the fire-retardant adhesive layer 22 on one side by applying an adhesive held in a container 42, and a first pressing roller 46, which may contact the first coating roller 44 to aid the transporting of the aluminum film 20.

The aluminum film 20 may be wound around the supply roller 41 in the form of a roll, and may be transported by the rotations of the first coating roller 44 and the first pressing roller 46.

Although the descriptions above refer to an adhesive held in a container 42 being applied onto the aluminum film 20 by way of the first coating roller 44, it is also possible to coat the fire-retardant adhesive layer 22 on one side of the aluminum film 20 by spraying the adhesive through nozzles (not shown).

The first attachment unit 50 may include a first attaching roller 52, which may contact a back side of the aluminum film 20 coated with the fire-retardant adhesive layer 22 to transport the aluminum film, and a second attaching roller 54, which may contact one side of the glass fiber fabric 10 to aid the attachment between the glass fiber fabric 10 and the aluminum film 20.

The first attaching roller 52 and the second attaching roller 54 may firmly press and attach the glass fiber fabric 10 with the aluminum film 20, so that the fire-retardant adhesive layer 22 may be spread evenly over the attachment surface, and may thus aid the attachment between the glass fiber fabric 10 and the aluminum film 20.

The second coating unit 60 may include a second coating roller 64, which may transport the combined glass fiber fabric 10 and aluminum film 20 and apply an adhesive held in a container 62 to thereby coat a fire-retardant adhesive layer 24 on the other side of the aluminum film 20, and a second pressing roller 66, which may contact the second coating roller 64 to aid the transporting of the glass fiber fabric 10 and the aluminum film 20.

Although the descriptions above refer to an adhesive held in a container 62 being applied onto the aluminum film 20 by way of the second coating roller 64, it is also possible to coat the fire-retardant adhesive layer 24 on the other side of the aluminum film 20 by spraying the adhesive through nozzles (not shown).

The second attachment unit 70 may include a third attaching roller 72, which may transport the glass fiber fabric 10 and the aluminum film 20 coated with the fire-retardant adhesive layer 24, and a fourth attaching roller 74, which may contact one side of the other glass fiber fabric 30 to aid the attachment between the other glass fiber fabric 30 and the aluminum film 20.

The third attaching roller 72 and the fourth attaching roller 74 may firmly press and attach the other glass fiber fabric 30 with the aluminum film 20, so that the fire-retardant adhesive layer 22 may be spread evenly over the attachment surface, and may thus aid the attachment between the other glass fiber fabric 30 and the aluminum film 20.

A supplementary attachment unit 80 may further be included, which may press both sides of the nonflammable insulating sheet dispensed from the second attachment unit 70 with multiple rollers.

The supplementary attachment unit 80 may serve to press the fire-retardant adhesive layer 22 coated between the glass fiber fabric 10 and the aluminum film 20 as well as the fire-retardant adhesive layer 24 coated between the other glass fiber fabric 30 and the aluminum film 20, and as the adhesive spreads evenly once more over the entire surface, the nonflammable insulating sheet thus manufactured can maintain stiffness, to allow fastening like a panel onto a wall by way of staples, nails, pieces, etc., for use as thermal insulation in a building, and to allow easy cutting by cutters, scissors, and the like.

The nonflammable insulating sheet transported by and dispensed from the supplementary attachment unit 80 may be wound around a winding roller 90 to be outputted as a product.

The nonflammable coating layer formed on the glass fiber fabrics 10, 30 may include one or more of melamine and water-based acrylic, and may be composed by mixing melamine cyanurate, water-based polyurethane, a surface treatment agent, and water.

The nonflammable coating layer may further include at least one or more of phosphorus pentoxide (P2O5), nitrogen, and urea, for increased nonflammability.

For the aluminum film 20, an aluminum foil processed by rolling an aluminum material or an aluminum alloy to a predetermined thickness may be applied, and the fire-retardant adhesive layer 22, 24 may advantageously be such that has a nonflammable or a fire-retardant quality.

Features that were not described with respect to the apparatus for manufacturing a nonflammable insulating sheet according to an embodiment of the present invention may be applied from the features described with reference to the nonflammable insulating sheet set forth above.

Referring to FIG. 1 through FIG. 4, a method for manufacturing a nonflammable insulating sheet according to an embodiment of the present invention may include a first coating operation (S10) of coating a fire-retardant adhesive layer 22 on one side of an aluminum film 20, a first combining operation (S20) of pressing together and combining the aluminum film 20 with a glass fiber fabric 10 having a nonflammable coating layer formed on one side or on either side, a second coating operation (S30) of transporting the combined glass fiber fabric 10 and aluminum film 20 and coating a fire-retardant adhesive layer 24 on the other side of the aluminum film 20, and a second combining operation (S40) of pressing together and combining the aluminum film 20 having the fire-retardant adhesive layer 24 coated on the other side with another glass fiber fabric 30 that has a nonflammable coating layer formed on one side or on either side, to manufacture a nonflammable insulating sheet.

After the second combining operation (S40), the method may further include a supplementary pressing operation (S50) of further pressing the nonflammable insulating sheet with a pair of rollers of a supplementary attachment unit 80, and a winding operation (S60) of winding the nonflammable insulating sheet around a winding roller 90.

The supplementary pressing operation (S50) may be a process for using the pair of rollers of the supplementary attachment unit 80 to press the fire-retardant adhesive layer 22 coated between the glass fiber fabric 10 and the aluminum film 20 and the fire-retardant adhesive layer 24 coated between the other glass fiber fabric 30 and the aluminum film 20. By having the adhesive spread evenly over the entire surface once more, the manufactured nonflammable insulating sheet can be made to maintain stiffness, to allow fastening like a panel onto a wall by way of staples, nails, pieces, etc., for application as thermal insulation in a building, and to allow easy cutting by cutters, scissors, and the like.

The nonflammable coating layer may include one or more of melamine and water-based acrylic, and may be composed by mixing melamine cyanurate, water-based polyurethane, a surface treatment agent, and water.

The nonflammable coating layer may further include at least one or more of phosphorus pentoxide (P2O5), nitrogen, and urea, for increased nonflammability.

The aluminum film 20 may be an aluminum foil processed by rolling an aluminum material or an aluminum alloy to a predetermined thickness.

The fire-retardant adhesive layer 22, 24 may have a nonflammable or a fire-retardant property.

The nonflammable coating layer may be coated such that a nonflammable coating fluid is permeated evenly through the fibers of the fabric by a repeated up-and-down transporting by multiple rollers that are installed immersed in a container holding the nonflammable coating fluid.

Here, the glass fiber fabrics 10, 30 applied with the nonflammable coating fluid, as it is dispensed from the container, may be moved between a pair of rollers to be compressed and squeezed, so that the nonflammable coating layer may be permeated more deeply.

Features that were not described with respect to the method for manufacturing a nonflammable insulating sheet according to an embodiment of the present invention may be applied from the features described with reference to the nonflammable insulating sheet or with reference to the apparatus for manufacturing a nonflammable insulating sheet set forth above.

Nonflammable insulating sheets according to an embodiment of the present invention can be applied in several layers attached together on walls, ceilings, floors, etc., to further enhance the effects of thermal insulation and sound insulation.

While the present invention was described using embodiments illustrated in the drawings, these are for illustrative purposes only, and those of ordinary skill in the art would understand that various modifications and equivalents can be derived from the above.

Therefore, the true technical scope of protection for the present invention is to be defined by the scope of claims below.

What is claimed is:

1. A nonflammable insulating sheet comprising:
a glass fiber fabric having a nonflammable coating layer formed on one side or both sides thereof;
an aluminum film arranged on one side of the glass fiber fabric; and
another glass fiber fabric arranged on a side of the aluminum film opposite from the glass fiber fabric and having a nonflammable coating layer formed on one side or both sides thereof,
wherein the nonflammable insulating sheet is formed by forming a fire-retardant adhesive layer on both sides of the aluminum film and pressing with the aluminum film arranged between the glass fiber fabrics.

2. The nonflammable insulating sheet according to claim 1, wherein the aluminum film is an aluminum foil processed by rolling an aluminum material or an aluminum alloy to a predetermined thickness.

3. The nonflammable insulating sheet according to claim 1, wherein the nonflammable coating layer comprises water and melamine cyanurate, water-based polyurethane, and a surface treatment agent.

4. The nonflammable insulating sheet according to claim 1, wherein the nonflammable coating layer further comprises one or more of melamine and water-based acrylic to provide a smooth surface.

5. The nonflammable insulating sheet according to claim 1, wherein the nonflammable coating layer further comprises at least one or more of phosphorus pentoxide (P2O5), nitrogen, and urea to increase nonflammability.

6. The nonflammable insulating sheet according to claim 1, wherein the nonflammable coating layer is coated by a repeated up-and-down transporting by a plurality of rollers installed immersed in a container holding a nonflammable coating fluid, and
printing is applied on an externally exposed surface of the glass fiber fabric and the another glass fiber fabric.

7. An apparatus for manufacturing a nonflammable insulating sheet, the apparatus comprising:
a first coating unit configured to supply an aluminum film and coat with a fire-retardant adhesive layer;
a first attachment unit configured to transport the aluminum film coated with the adhesive, supply a glass fiber fabric having a nonflammable coating layer formed thereon, and attach the glass fiber fabric with the aluminum film;
a second coating unit configured to transport the glass fiber fabric and the aluminum film in a combined state and coat a fire-retardant adhesive layer onto the other side of the aluminum film;
a second attachment unit configured to supply another glass fiber fabric having a nonflammable coating layer formed thereon to the aluminum film and attach with the fire-retardant adhesive layer coated on the other side of the aluminum film to thereby manufacture a nonflammable insulating sheet; and
a supplementary attachment unit configured to press both sides of the nonflammable insulating sheet dispensed from the second attachment unit with a plurality of rollers.

8. The apparatus for manufacturing a nonflammable insulating sheet according to claim 7, wherein the first coating unit comprises:
a first coating roller configured to transport the aluminum film supplied from a supply roller and apply an adhesive held in a container to thereby form a fire-retardant adhesive layer on one side; and
a first pressing roller contacting the first coating roller to aid the transporting of the aluminum film.

9. The apparatus for manufacturing a nonflammable insulating sheet according to claim 7, wherein the first attachment unit comprises:
a first attaching roller contacting a back side of the aluminum film coated with the fire-retardant adhesive layer to transport the aluminum film; and
a second attaching roller contacting one side of the glass fiber fabric to aid the attachment of the glass fiber fabric and the aluminum film.

10. The apparatus for manufacturing a nonflammable insulating sheet according to claim 7, wherein the second coating unit comprises:
a second coating roller configured to transport the combined glass fiber fabric and aluminum film and apply an adhesive held in a container to thereby form a fire-retardant adhesive layer on the other side of the aluminum film; and
a second pressing roller contacting the second coating roller to aid the transporting of the combined glass fiber fabric and aluminum film.

11. The apparatus for manufacturing a nonflammable insulating sheet according to claim 7, wherein the second attachment unit comprises:
a third attaching roller transporting the glass fiber fabric and the aluminum film coated with the fire-retardant adhesive layer; and
a fourth attaching roller contacting one side of the another glass fiber fabric to aid the attachment of the other glass fiber fabric and the aluminum film.
